(19) United States
(12) Patent Application Publication
(10) Pub. No.: US 2023/0073326 A1
(43) Pub. Date: Mar. 9, 2023

(54) PLANNING FOR AGENT CONTROL USING LEARNED HIDDEN STATES

(71) Applicant: DeepMind Technologies Limited, London (GB)

(72) Inventors: Julian Schrittwieser, London (GB); Ioannis Antonoglou, Cambridge (GB); Thomas Keisuke Hubert, London (GB)

(21) Appl. No.: 17/794,797

(22) PCT Filed: Jan. 28, 2021
(86) PCT No.: PCT/IB2021/050691

§ 371 Date: Jul. 22, 2022

(30) Foreign Application Priority Data
Jan. 28, 2020 (GR) 20200100037

(51) Int. Cl. G06N 7/00; G06N 5/00; G06K 9/62

(52) U.S. Cl. CPC G06N 7/005; G06K 9/6256; G06K 9/6262; G06N 5/003

(57) ABSTRACT

Methods, systems, and apparatus, including computer programs encoded on computer storage media, for selecting actions to be performed by an agent interacting with an environment to cause the agent to perform a task. One of the methods includes: receiving a current observation characterizing a current environment state of the environment; performing a plurality of planning iterations to generate plan data that indicates a respective value to performing the task of the agent performing each of the set of actions in the environment and starting from the current environment state, wherein performing each planning iteration comprises selecting a sequence of actions to be performed by the agent starting from the current environment state based on outputs generated by a dynamics model and a prediction model; and selecting, from the set of actions, an action to be performed by the agent in response to the current observation based on the plan data.

### CROSS REFERENCE TO RELATED APPLICATION

This application claims the benefit under 35 U.S.C. §119(a) of the filing date of Greek Patent Application No. 20200100037, filed in the Greek Patent Office on Jan. 28, 2020. The disclosure of the foregoing application is herein incorporated by reference in its entirety.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a reinforcement learning system that controls an agent interacting with an environment by, at each of multiple time steps, processing data characterizing the current state of the environment at the time step (i.e., an “observation”) to select an action to be performed by the agent from a set of actions.

At each time step, the state of the environment at the time step depends on the state of the environment at the previous time step and the action performed by the agent at the previous time step.

Generally, the system receives the current observation and performs a plurality of planning iterations. The system then selects the action to be performed in response to the current observation based on the results of the planning iterations. At each planning iteration, the system generates a sequence of actions that progress the environment to new states starting from the state represented by the current observation. Unlike conventional systems, the system does not perform the planning iterations using a simulator of the environment, i.e., does not use a simulator of the environment to determine which state the environment will transition into as a result of a given action being performed in a given state. Instead, the system uses (i) a learned dynamics model that is configured to receive as input a) a hidden state corresponding to an input environment state and b) an input action from the set of actions and to generate as output at least a hidden state corresponding to a predicted next environment state that the environment would transition into if the agent performed the input action when the environment is in the input environment state; and (ii) a prediction model that is configured to receive as input the hidden state corresponding to the predicted next environment state and to generate as output a) a predicted policy output that defines a score distribution over the set of actions and b) a value output that represents a value of the environment being in the predicted next environment state to performing the task. Each hidden state is a lower-dimensional representation of an observation. Thus, the system performs planning using only these hidden states without ever being required to reconstruct the full state of the environment or even a full observation characterizing a state.

In general, one innovative aspect of the subject matter described in this specification can be embodied in methods for selecting, from a set of actions, actions to be performed by an agent interacting with an environment to cause the agent to perform a task, the method comprising: receiving a current observation characterizing a current environment state of the environment; performing a plurality of planning iterations to generate plan data that indicates a respective value to performing the task of the agent performing each of multiple actions from the set of actions in the environment and starting from the current environment state, wherein performing each planning iteration comprises: selecting a sequence of actions to be performed by the agent starting from the current environment state by traversing a state tree of the environment, the state tree of the environment having nodes that represent environment states of the environment and edges that represent actions that can be performed by the agent that cause the environment to transition states, and wherein traversing the state tree comprises: traversing, using statistics for edges in the state tree, the state tree starting from a root node of the state tree representing the current environment state until reaching a leaf node in the state tree; processing a hidden state corresponding to an environment state represented by the leaf node using a prediction model that is configured to receive as input the hidden state and to generate as output at least a predicted policy output that defines a score distribution over the set of actions; sampling a proper subset of the set of actions; updating the state tree by, for each sampled action, adding, to the state tree, a respective outgoing edge from the leaf node that represents the sampled action; and updating the statistics by, for each sampled action, associating the respective outgoing edge representing the sampled action with a prior probability for the sampled action that is derived from the predicted policy output; and selecting an action to be performed by the agent in response to the current observation using the plan data.

Sampling a proper subset of the set of actions may comprise: generating data defining a sampling distribution from the score distribution; and sampling a fixed number of samples from the sampling distribution. Generating the sampling distribution may comprise modulating the score distribution with a temperature parameter. When the leaf node is the same as the root node, generating the sampling distribution may comprise adding noise to the score distribution. The method may further comprise comprising generating the respective prior probability for the sampled action by applying a correction factor to the score for the action in the score distribution. The correction factor may be based on (i) a number of times that the sampled action was sampled in the fixed number of samples and (ii) a score assigned to the sampled action in the sampling distribution The correction factor may be equal to a ratio of (i) a ratio of the number of time that the sampled action was sampled to the fixed number of samples and (ii) the score assigned to the sampled action in the sampling distribution. The plan data may comprise a respective visit count for each outgoing edge from the root node that represents a number of times that the corresponding action was selected during the plurality of planning iterations, and wherein selecting the action to be performed by the agent in response to the current observation may comprise selecting an action using the respective visit counts.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

Particular embodiments of the subject matter described in this specification can be implemented so as to realize one or more of the following advantages.

This specification describes effectively performing planning for selecting actions to be performed by an agent when controlling the agent in an environment for which a perfect or very high-quality simulator is not available. In particular, tree-based planning methods have enjoyed success in challenging domains where a perfect simulator that simulates environment transition is available. However, in real-world problems the dynamics governing the environment are typically complex and unknown, and planning approaches have so far failed to yield the same performance gains. The described techniques use a learned model combined with an MDP planning algorithm e.g., a tree-based search with a learned model to achieves high quality performance in a range of challenging and visually complex domains, without any knowledge of their underlying dynamics. The described techniques learn a model that, when applied iteratively, predicts the quantities most directly relevant to planning: the action-selection policy, the value function, and, when relevant, the reward, allowing for excellent results to be achieved on a variety of domains where conventional planning techniques had failed to show significant improvement.

The described planning techniques are easily adaptable to controlling agent to perform many complex tasks, e.g., robotic tasks, which require selecting an action from a large discrete action space, a continuous action space, or a hybrid action space, i.e., with some sub-actions being discrete and others being continuous. Traversing different states of the environment using tree-based search could be infeasible when the action space is large or continuous. By repeatedly sampling a subset of the actions and expanding the state tree maintained during the tree-based search using only the sampled actions, i.e., rather than using every possible action in the entire action space, the applicability of the described planning techniques can be extended into these complex tasks with no significant increase in computational overhead of the planning process. Thus, the described techniques can be used to control agents for tasks with large discrete action spaces, continuous action spaces, or hybrid action spaces with reduced latency and reduced consumption of computational resources while still maintaining effective performance.

This specification also describes techniques for training the models used to select actions in a sample-efficient manner. Offline reinforcement learning training has long been an effective algorithm because the models used to select actions can be trained without the need of controlling the agent to interact with the real-environment. However, in environments that have complex dynamics, e.g., in real-world environments interacted with by robots or other mechanical agents, predictions made by the dynamics model or prediction model or both will be error-prone and introduce a bias into the learning process. This often causes existing approaches that use a dynamics model or prediction model or both to fail to learn a high-performing policy when being trained offline, i.e., without being able to interact with the environment.

The described techniques, however, account for bias and uncertainty in these models to allow an effective policy to be learned with much greater sample efficiency even for very complex tasks. In particular, by employing a reanalyzing technique to iteratively re-compute, for offline training data that is already maintained by the system, new target policy outputs and new target value outputs based on model outputs generated in accordance with recently updated model parameter values during the offline training of the system, the described techniques can account for dynamics model uncertainty, prediction model bias, or both while still reducing the number of actual trajectories from the environment that are required to learn an effective action selection policy. This is particularly advantageous in cases where the agent is a robot or other mechanical agent interacting with the real-world environment because collecting actual samples from the environment adds wear to the agent, increases the chance of mechanical failure of the agent, and is very time-intensive.

As such, the disclosed techniques can increase the speed of training of models used in selecting actions to be performed by agents and reduce the amount of training data needed to effectively train those models. Thus, the amount of computing resources necessary for the training of the models can be reduced. For example, the amount of memory required for storing the training data can be reduced, the amount of processing resources used by the training process can be reduced, or both.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for selecting actions to be performed by an agent interacting with an environment.

FIG. 3A is an example illustration of performing one planning iteration to generate plan data.

FIG. 3B is an example illustration of selecting actions to be performed by an agent based on the generated plan data.

FIG. 4 is a flow diagram of another example process for selecting actions to be performed by an agent interacting with an environment.

FIG. 5 is a flow diagram of an example process for training a reinforcement learning system.

FIG. 6 is an example illustration of training a reinforcement learning system.

FIG. 7 is a flow diagram of an example process for reanalyzing a reinforcement learning system.

Like reference numbers and designations in the various drawings indicate like elements.

### DETAILED DESCRIPTION

This specification describes a reinforcement learning system that controls an agent interacting with an environment by, at each of multiple time steps, processing data characterizing the current state of the environment at the time step (i.e., an “observation”) to select an action to be performed by the agent from a set of actions.

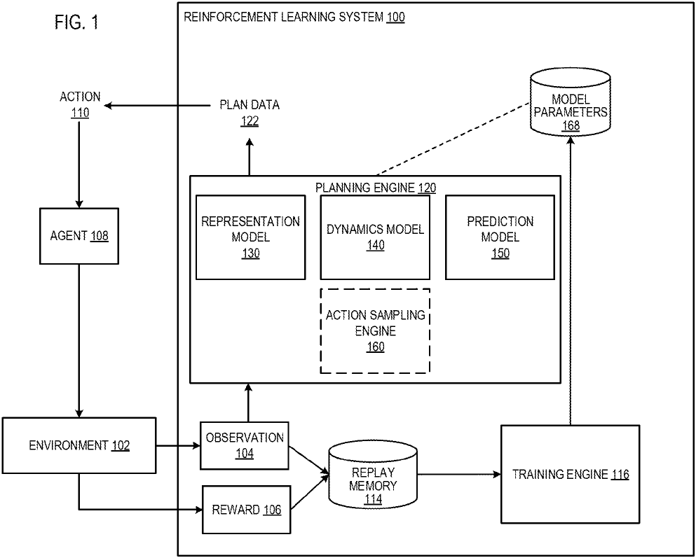

FIG. 1 shows an example reinforcement learning system 100. The reinforcement learning system 100 is an example of a system implemented as computer programs on one or more computers in one or more locations in which the systems, components, and techniques described below are implemented.

The reinforcement learning system 100 selects actions 110 to be performed by an agent 108 interacting with an environment 102 at each of multiple time steps. At each time step, the state of the environment 102 at the time step depends on the state of the environment at the previous time step and the action performed by the agent at the previous time step. In order for the agent 108 to interact with the environment 102, the system 100 receives a current observation 104 characterizing a current state of the environment 102 and uses a planning engine 120 to perform a plurality of planning iterations to generate plan data 122. The plan data 122 can include data that indicates a respective value to performing the task (e.g., in terms of rewards 106) of the agent 108 performing each of a set of possible actions in the environment 102 and starting from the current state. In particular, at each planning iteration, the system 100 generates a sequence of actions that progress the environment 102 to new, predicted (i.e., hypothetical) future states starting from the state represented by the current observation 104. Generating plan data 122 in this way allows for the system 100 to effectively select the actual action to be performed by the agent in response to the current observation 104 by first traversing, i.e., during planning, possible future states of the environment starting from the state represented by the current observation 104.

In some implementations, the system 100 can generate the plan data 122 by performing a look ahead search guided by the outputs of the planning engine 120. The specifics of the components of the planning engine 120 and its outputs will be described further below. For example, the look ahead search may be a tree search, e.g., a Monte-Carlo tree search, where the state tree includes nodes that represent states of the environment 102 and directed edges that connect nodes in the tree. An outgoing edge from a first node to a second node in the tree represents an action that was performed in response to an observation characterizing the first state and resulted in the environment transitioning into the second state.

In such implementations, the plan data 122 can include statistics data for each of some or all of the node-edge (i.e., state-action) pairs that has been compiled as a result of repeatedly running the planning engine 120 to generate different outputs starting from the node that represents the current state of the environment. For example, the plan data 122 can include, for each outgoing edge of a root node of the state tree, (i) an action score Q for the action represented by the edge, (ii) a visit count N for the action represented by the edge that represents a number of times that the action was selected during the plurality of planning iterations, and (iii) a prior probability P for the action represented by the edge. During planning, the root node of the state tree corresponds to the state characterized by the current observation 104.

For any given node representing a given state of the environment, the action score Q for an action represents the current estimate of the return that will be received if the action is performed in response to an observation characterizing the given state. A return refers to a cumulative measure of “rewards” 106 received by the agent, for example, a time-discounted sum of rewards. The agent 108 can receive a respective reward 106 at each time step, where the reward 106 is specified by a scalar numerical value and characterizes, e.g., a progress of the agent 108 towards completing an assigned task. The visit count N for the action is the current number of times that the action has been performed by the agent 108 in response to observations characterizing the given state. And the prior probability P represents the likelihood that the action is the action that should be performed in response to observations characterizing the given state, i.e., the action that will maximize the received return relative to all other actions that can be performed in response to an observation.

The system 100 can maintain the plan data 122 at a memory device accessible to the system 100. While logically described as a tree, the plan data 122 generated by using the planning engine 120 may be represented by any of a variety of convenient data structures, e.g., as multiple triples or as an adjacency list.

At each planning iteration, the system 100 can generate the sequence of actions by repeatedly (i.e., at each of multiple planning steps) selecting an action a according to the compiled statistics for a corresponding node-edge pair beginning from that corresponds to the root node, for example, by maximizing over an upper confidence bound:

$$arg {max}_{a} \left[Q \left(s , a\right) + P \left(s , a\right) ⋅ \frac{\sqrt{{Σ}_{b} N \left(s , b\right)}}{1 + N \left(s , a\right)} \left({c}_{1} + log \left(\frac{{Σ}_{b} N \left(s , b\right) + {c}_{2} + 1}{{c}_{2}}\right)\right)\right]$$

where c1 and c2 are tunable hyperparameters used to control the influence of the prior probability P relative to the action score Q.

Example look ahead search algorithms including action selection, state tree expansion and statistics update algorithms are described in more detail in U.S. Pat. publication 20200143239 entitled “Training action selection neural networks using look-ahead search” Simonyan et al. filed on May 28, 2018 and published on May 7, 2020, which is herein incorporated by reference, and in non-patent literatures “Mastering the game of go without human knowledge” Silver et al. in Nature, 550:354-359, October 2017, and “Bandit based monte-carlo planning” Kocsis et al. in European conference on machine learning, pages 282-293. Springer, 2006.

After planning, the system 100 proceeds to select the actual action 110 to be performed by the agent 108 in response to the received current observation 104 based on the results of the planning iterations, i.e., based on the plan data 122. In particular, in these implementations, the plan data 122 can include statistics data that has been compiled during planning for each outgoing edge of the root node of the state tree, i.e., the node that corresponds to the state characterized by the current observation 104, and the system 100 can select the actual action 110 based on the statistics data for the node-edge pairs corresponding to the root node.

For example, the system 100 can make this selection proportional to the visit count for each outgoing edge of the root node of the state tree. That is, an action from the set of all possible actions that has been selected most often during planning when the environment 102 is in a state characterized by the current observation 104, i.e., the action corresponding to the outgoing edge from the root node that has the highest visit count in the plan data, may be selected as the actual action 110 to be performed by the agent in response to the current observation. Additionally or instead, for each outgoing edge of the root node of the state tree, the system 100 can map the visit count to a probability distribution, e.g., an empirical probability (or relative frequency) distribution, and then sample an action in accordance with the respective probability distributions determined for the outgoing edges of the root node. The probability distribution can, for example, assign each outgoing edge a probability that is equal to the ratio of (i) the visit count for the edge to (ii) the total visit count of all of the outgoing edges from the root node or can be a noisy empirical distribution that adds noise to the ratios for the outgoing edges. The sampled action can then be used as the actual action 110 to be performed by the agent in response to the current observation.

As another example, the system 100 can make this selection by determining, from the sequences of actions in the plan data, a sequence of actions that has a maximum associated value and thereafter selecting, as the actual action 110 to be performed by the agent in response to the current observation 104, the first action in the determined sequence of actions.

Typically, to select the actual action 110, the system 100 would first traverse possible future states of the environment by using each action in the set of possible actions that can be performed by the agent 102. When the action space is continuous, i.e., all of the action values in an individual action are selected from a continuous range of possible values, or hybrid, i.e., one or more of the action values in an individual action are selected from a continuous range of possible values, this is not feasible. When the action space is discrete but includes a large number of actions, this is not computationally efficient and consumes a large amount of computational resources to select a single action, as it can require a large number of planning iterations by using the planning engine 120.

Instead, the planning engine 120 can use an action sampling engine 160 to reduce the number of actions that need to be evaluated during planning while still allowing for accurate control of the agent 102, i.e., for the selection of a high quality action 110 in response to any given observation 104.

In particular, the planning engine 120 uses the action sampling engine 160 to select a proper subset of the actions in the set of possible actions and to perform planning by using only the actions in the proper subset, as will be described further below. The number of actions in the proper subset is generally much smaller than the total number of actions in the set of possible actions. For example, even when the action space includes on the order of 5^21 possible actions, the system can still accurately control the agent based on the plan data 122 generated by using only 20 actions included in the proper subset of possible actions. This can allow the system 100 to control the agent 102 with reduced latency and while consuming fewer computational resources than conventional approaches.

In more detail, the planning engine 120 includes a representation model 130, a dynamics model 140, a prediction model 150 and, in some cases, the action sampling engine 160.

The representation model 130 is a machine learning model that maps the observation 104 which typically includes high-dimensional sensor data, e.g., image or video data, into lower-dimensional representation data. The representation model 130 can be configured to receive a representation model input including at least the current observation 104 and to generate as output a hidden state corresponding to the current state of the environment 102.

As used throughout this document, a “hidden state” corresponding to the current state of the environment 102 refers to a characterization of the environment 102 as an ordered collection of numerical values, e.g., a vector or matrix of numerical values, and generally has a lower dimensionality, simpler modality, or both than the observation 104 itself. In various implementations, each hidden state corresponding to the current state of the environment 102 can include information about the current environment state and, optionally, information about one or more previous states that the environment transitioned into prior to the current state.

The dynamics model 140 is a machine learning model which, given information at a given time step, is able to make a prediction about at least one future time step that is after the given time step.

The dynamics model 140 can be configured to receive as input a) a hidden state corresponding to an input environment state and b) data specifying an input action from a set of possible actions and to generate as output a) a hidden state corresponding to a predicted next environment state that the environment would transition into if the agent performed the input action when the environment is in the input environment state, and, in some cases, b) data specifying a predicted immediate reward value that represents an immediate reward that would be received if the agent performed the input action when the environment is in the input environment state. For example, the immediate reward value can be a numerical value that represents a progress in completing the task as a result of performing the input action when the environment is in the input environment state.

The prediction model 150 is a machine learning model that is configured to predict the quantities most directly relevant to planning: the action-selection policy, the value function, and, when relevant, the reward. The prediction model 150 can be configured to receive as input the hidden state corresponding to a given environment state and to generate as output a) a predicted policy output that can be used to determine a predicted next action to be performed by the agent at the given environment state and b) a value output that represents a value of the environment being in the given environment state to performing the task.

In one example, the predicted policy output may define a score distribution over a set of possible actions that can be performed by the agent, e.g., may include a respective numerical probability value for each action in the set of possible actions. If being used to control the agent, the system 100 could select the action to be performed by the agent, e.g., by sampling an action in accordance with the probability values for the actions, or by selecting the action with the highest probability value.

In another example, the value output may specify a numerical value that represents an overall progress toward the agent accomplishing one or more goals when the environment is in the given environment state.

The representation, dynamics, and prediction models can each be implemented as a respective neural network with any appropriate neural network architecture that enables it to perform its described function. In one example, when the observations are images, the representation and dynamics model can each be implemented as a respective convolutional neural network with residual connections, e.g., a neural network built up of a stack of residual blocks that each include one or more convolutional layers, in addition to one or more normalization layers or activation layers. In another example, the prediction model 150 may be implemented as a neural network that includes an input layer (which receives a hidden state input), followed by one or more convolutional layers, or one or more fully-connected layers, and an output layer (which outputs the score distribution).

Other examples of neural network architectures that the representation, dynamics, and prediction models can have include graph neural networks, multi-layer perceptron neural networks, recurrent neural networks, and self-attention neural networks.

At a high level, the action sampling engine 160 includes software that is configured to receive as input the predicted policy output of the prediction model 150 and to process the input to generate as output data defining a sampling distribution.

The sampling distribution can be a distribution over some or all of the possible actions that can be performed by the agent, e.g., may include a respective numerical probability value for each of multiple actions in the entire set of possible actions. The sampling distribution may, but need not, be the same as the score distribution defined in the predicted policy output of the prediction model 150.

In some cases, the action sampling engine 160 can generate the sampling distribution by modulating the score distribution defined by the predicted policy output with a temperature parameter τ. For example, the temperature parameter τ can be any positive value (with values greater than one encouraging more diverse samples), and the sampling distribution can be generated in the form of P^{⅟τ}, where P is the prior probability that is derived from the predicted policy output.

In some cases, e.g., at the beginning of each planning iteration, i.e., when the leaf node is the same as the root node, the action sampling engine 160 can additionally add exploration noise such as dirichlet noise to the score distribution defined by the predicted policy output to facilitate action exploration.

When used during planning, the planning engine 120 then samples a fixed number of actions from the sampling distribution to generate the proper subset of actions that will be used in the planning to progress the environment into different future states.

In some implementations, the environment 102 is a real-world environment and the agent 108 is a mechanical agent interacting with the real-world environment, e.g., a robot or an autonomous or semi-autonomous land, air, or sea vehicle navigating through the environment.

In these implementations, the observations 104 may include, e.g., one or more of images, object position data, and sensor data to capture observations as the agent as it interacts with the environment, for example sensor data from an image, distance, or position sensor or from an actuator.

For example in the case of a robot the observations 104 may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations 104 may also include, for example, sensed electronic signals such as motor current or a temperature signal; and/or image or video data for example from a camera or a LIDAR sensor, e.g., data from sensors of the agent or data from sensors that are located separately from the agent in the environment.

In the case of an electronic agent, the environment 102 may be a data compression environment, data decompression environment or both. The agent 108 may be configured to receive as observations 104 input data (e.g., image data, audio data, video data, text data, or any other appropriate sort of data) and select and perform a sequence of actions 110, e.g., data encoding or compression actions, to generate a compressed representation of the input data. The agent 108 may be similarly configured to process the compressed data to generate an (approximate or exact) reconstruction of the input data.

In the case of an electronic agent the observations 104 may include data from one or more sensors monitoring part of a plant or service facility such as current, voltage, power, temperature and other sensors and/or electronic signals representing the functioning of electronic and/or mechanical items of equipment.

In these implementations, the actions 110 may be control inputs to control the robot, e.g., torques for the joints of the robot or higher-level control commands, or the autonomous or semi-autonomous land, air, sea vehicle, e.g., torques to the control surface or other control elements of the vehicle or higher-level control commands.

In other words, the actions 110 can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g., braking and/or acceleration of the vehicle.

In the case of an electronic agent the observations 104 may include data from one or more sensors monitoring part of a plant or service facility such as current, voltage, power, temperature and other sensors and/or electronic signals representing the functioning of electronic and/or mechanical items of equipment. For example the real-world environment may be a manufacturing plant or service facility, the observations may relate to operation of the plant or facility, for example to resource usage such as power consumption, and the agent may control actions or operations in the plant/facility, for example to reduce resource usage. In some other implementations the real-world environment may be a renewal energy plant, the observations may relate to operation of the plant, for example to maximize present or future planned electrical power generation, and the agent may control actions or operations in the plant to achieve this.

In some other applications the agent may control actions in a real-world environment including items of equipment, for example in a data center, in a power/water distribution system, or in a manufacturing plant or service facility. The observations may then relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility.

As another example, the environment 102 may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/ intermediates/ precursors and/or may be derived from simulation.

As another example, the environment 102 may be an online platform such as a next-generation virtual assistant platform, a personalized medicine platform, or search-and-rescue platform where the observations 104 may be in form of digital inputs from a user of the platform, e.g., a search query, and set of possible actions may include candidate content items, e.g., recommendations, alerts, or other notifications, for presentation in a response to the user input.

In some implementations the environment 102 may be a simulated environment and the agent is implemented as one or more computers interacting with the simulated environment.

The simulated environment may be a motion simulation environment, e.g., a driving simulation or a flight simulation, and the agent may be a simulated vehicle navigating through the motion simulation. In these implementations, the actions may be control inputs to control the simulated user or simulated vehicle.

In some implementations, the simulated environment may be a simulation of a particular real-world environment. For example, the system may be used to select actions in the simulated environment during training or evaluation of the control neural network and, after training or evaluation or both are complete, may be deployed for controlling a real-world agent in the real-world environment that is simulated by the simulated environment. This can avoid unnecessary wear and tear on and damage to the real-world environment or real-world agent and can allow the control neural network to be trained and evaluated on situations that occur rarely or are difficult to re-create in the real-world environment.

Generally, in the case of a simulated environment, the observations may include simulated versions of one or more of the previously described observations or types of observations and the actions may include simulated versions of one or more of the previously described actions or types of actions.

In some other applications the agent may control actions in a real-world environment including items of equipment, for example in an industrial facility, e.g., data center, a power/water distribution system, a manufacturing plant, or service facility, or commercial or residential building. The observations may then relate to operation of the facility or building. For example the observations may include observations of power or water usage by equipment, or observations of power generation or distribution control, or observations of usage of a resource or of waste production. The actions may include actions controlling or imposing operating conditions on items of equipment of the facility or building, and/or actions that result in changes to settings in the operation of the facility or building e.g. to adjust or turn on/off components of the facility or building. For example the components may be components that control the heating and/or cooling of the building or facility.

In some further applications, the environment is a real-world environment and the agent manages distribution of tasks across computing resources e.g. on a mobile device and/or in a data center. In these implementations, the actions may include assigning tasks to particular computing resources, e.g., scheduling workloads on a mobile device or across the computers in one or more data centers.

In some above implementations, at each time step, the system 100 receives a reward 106 based on the current state of the environment 102 and the action 110 of the agent 108 at the time step. For example, the system 100 may receive a reward 106 for a given time step based on progress toward the agent 108 accomplishing one or more goals. For example, a goal of the agent may be to navigate to a goal location in the environment 102.

In general, a training engine 116 trains the models included in the planning engine 120 to generate plan data 122 from which actions 110 that maximize the expected cumulative reward received by the system 100, e.g. a long-term time-discounted sum of rewards received by the system 100, can be effectively selected for performance by the agent 108 when interacting with the environment 102.

Specifically, the training engine 116 trains the prediction model 150 to generate a) predicted policy outputs from which actions similar to what would be selected according to a given look ahead search policy can be determined, and b) value outputs representing values of the environment that match the target values determined or otherwise derived from using the given policy. For example, the given look ahead search policy can be a tree-based search policy, e.g., a Monte-Carlo Tree Search policy, that is appropriate for traversing possible future states of the environment. The training engine 116 additionally trains the dynamics model 140 to generate predicted immediate reward values that match the actual rewards that would be received by the agent in response to performing different actions.

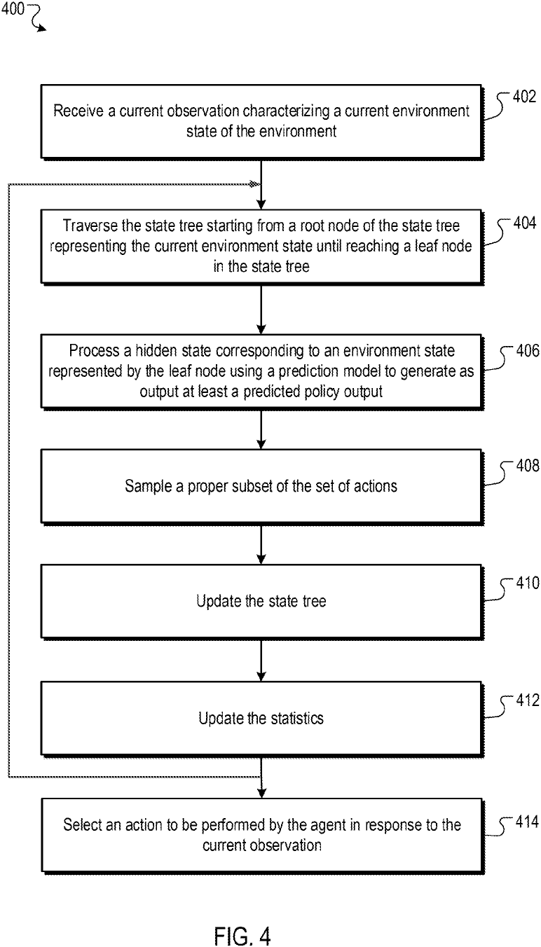

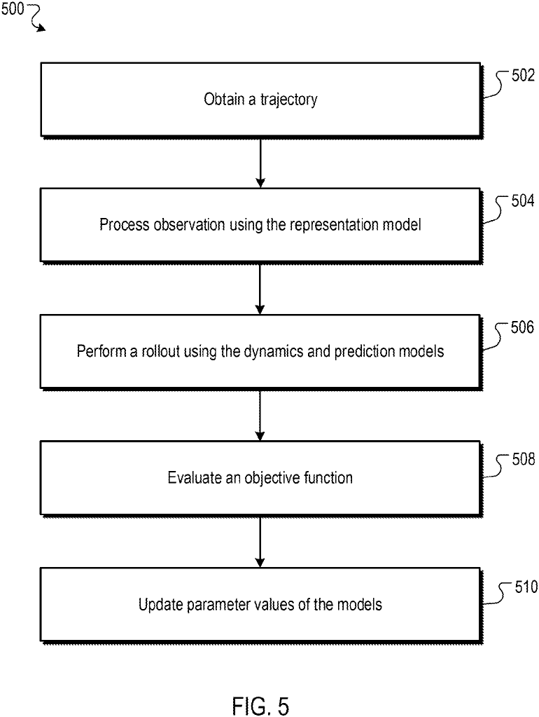

The training engine 116 can do this by using an appropriate training technique, e.g., an end-to-end by backpropagation-through-time technique, to jointly and iteratively adjust the values of the set of parameters 168 of the representation model 130, the dynamics model 140, and the prediction model 150, as described in more detail below with reference to FIGS. 4-5.

By performing the training in accordance with the aforementioned training objectives, e.g., by optimizing an objective function that only evaluates a total of three error terms corresponding to the predicted policy outputs, the value output, and the predicted immediate reward values, respectively, in addition to one or more optional regularization terms, the representation model 130 is not constrained or required, i.e., through training, to output hidden states that capture all information necessary to reconstruct the original observation. The representation model 130 is not constrained or required to output hidden states that match the unknown, actual state of the environment. And the representation model 130 is not constrained or required to model semantics of the environment through the hidden states. Instead, the representation model 130 can be trained, e.g., through backpropagation of computed gradients of the objective function, to output hidden states that characterize environment states in whatever way is relevant to generating current and future values and policy outputs. Not only does this drastically reduce the amount of information the system 100 needed to maintain and predict, thereby saving computational resources (e.g., memory and computing power), but this also facilitates learning of customized, e.g., task, agent, or environment-specific, rules or dynamics that can result in most accurate planning.

In some implementations, the training engine 116 trains the models included in the planning engine 120 from recent experiences (i.e., trajectories including observations, actions, and, optionally, rewards for previous time steps) stored in a replay memory 114. Generally the trajectories can be derived from experience information generated as a consequence of the interaction of the agent or another agent with the environment or with another instance of the environment for use in training the models. Each trajectory represents information about an interaction of the agent with the environment.

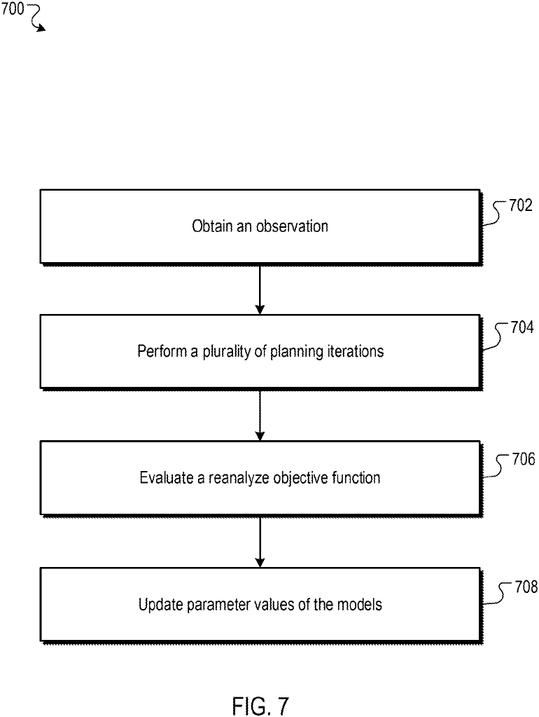

In some implementations, the system 100 can have control over the compositions of the trajectory data maintained at the replay memory 114, for example by maintaining some fraction, e.g., 80%, 70%, or 60%, of the trajectory data in the replay memory as new trajectory data, and the remaining fraction, e.g., the other 20%, 30%, or 40%, as old trajectory data, e.g., data that has been generated prior to the commencement of the training of the system or data that has already been used in training of the model. New trajectory data refers to experiences generated by controlling the agent 108 to interact with the environment 102 by selecting actions 108 using the planning engine 120 in accordance with recent parameter values of the models included in the planning engine 120 that have been determined as a result of the ongoing training and has not yet been used to train the models. The system can then train the models on both the new data and the old data in the replay memory 114. Training on old data is referred to as reanalyzing the old data and is described below with reference to FIG. 7.

In some cases, the system can be required to train the models in a data efficient manner, i.e., a manner that minimizes the amount of training data that needs to be generated by way of interaction of the agent with the environment. This can decrease the amount of computational resources consumed by the training and, when the agent is a real-world agent, reduce wear and tear on the mechanical agent that is caused by interacting with the environment during training. Generally, the system can achieve this data efficiency by increasing the fraction of old data to new data that is used for the training.

In yet other implementations, instead of or in addition to “old” data that has been generated as a result of interactions with the environment by the agent, the system can have access to demonstration data that is generated as a result of interactions with another “expert” agent with the environment. The expert agent can be an agent that has already been trained to perform the task or can be an agent that is being controlled by a human user. The system can also add this demonstration data (either instead of or in addition to “old” data generated as a result of interactions by the agent) to the replay memory as “old” data.

In other implementations, the system only has access to trajectory data that has previously been generated when the agent (or another agent) was controlled by a different policy and must train the machine learning models offline, i.e., without being able to control the agent to interact with the environment in order to generate new training data. In these implementations, the system can use the reanalyzing technique described above and below with reference to FIG. 7 on this trajectory data, i.e., by setting the fraction of old data (the trajectory data) to 1 and new data to 0. In some cases, after the system has trained the models to attain reasonable performance on the previously generated trajectory data, the system may be able to use the models to cause the agent to interact with the environment. In these cases, after the model is granted access, the system can revert to either training the models only on new data or on a mixture of new data and trajectory data in order to “fine-tune” the performance of the models.

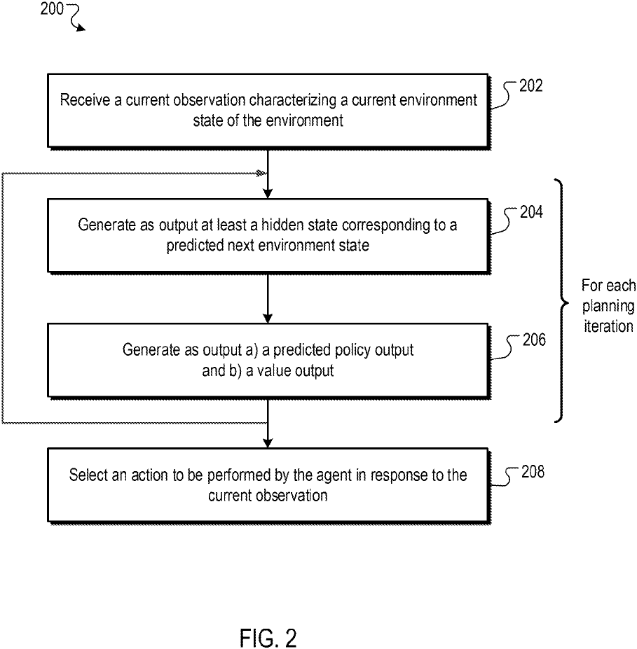

FIG. 2 is a flow diagram of an example process 200 for selecting actions to be performed by an agent interacting with an environment to cause the agent to perform a task. For convenience, the process 200 will be described as being performed by a system of one or more computers located in one or more locations. For example, a reinforcement learning system, e.g., the reinforcement learning system 100 of FIG. 1, appropriately programmed in accordance with this specification, can perform the process 200.

In general, when controlling the agent to actually interact with the environment, the system can perform an iteration of process 200 every time the environment transitions into a new state (referred to below as the “current” state) in order to select a new action from a set of possible actions to be performed by the agent in response to the new environment state.

The system receives a current observation (e.g., an image or a video frame) characterizing a current environment state of the environment (202).

The system processes, using a representation model and in accordance with trained values of the representation model parameters, a representation model input including the current observation to generate a hidden state corresponding to the current state of the environment. The hidden state is a compact representation of the observation, i.e., that has a lower dimensionality than the observation. In some implementations, the representation model input includes only the current observation. In some other implementations, the representation model input also includes one or more previous observations.

The system then performs multiple planning iterations to generate plan data that indicates a respective value to performing the task of the agent performing each of the set of actions in the environment and starting from the current environment state. Each planning iteration generally involves performing a look ahead search, e.g., a Monte-Carlo tree search, to repeatedly (i.e., at each of multiple planning steps of each planning iteration) select a respective action according to the compiled statistics for a corresponding node-edge pair in the state tree, as described above with reference to FIG. 1. This allows for the system traverse possible future states of the environment starting from the current state characterized by the current observation.

More specifically, at each planning iteration, the system begins the look ahead search starting from a root node of the state tree (which corresponds to the hidden state generated at step 202) and continues the look ahead search until a possible future state that satisfies termination criteria is encountered. For example, the look ahead search may be a Monte-Carlo tree search and the criteria may be that the future state is represented by a leaf node in the state tree. The system then expands the leaf node by using performing the following steps of 204-206. Briefly, to expand the leaf node, the system may add a new edge to the state tree for an action that is a possible (or valid) action to be performed by the agent (referred to below as “an input action”) in response to a leaf environment state represented by the leaf node (referred to below as an “input environment state”). For example, the action can be an action selected by the system according to the compiled statistics for a node-edge pair that corresponds to a parent node of the leaf node in the state tree. The system also initializes the statistics data for the new edge by setting the visit count and action scores for the new edge to zero.

The system processes (204), using the dynamics model and in accordance with trained values of the dynamics model parameters, a) a hidden state corresponding to an input environment state and b) data specifying an input action from a set of possible actions and to generate as output a) a hidden state corresponding to a predicted next environment state that the environment would transition into if the agent performed the input action when the environment is in the input environment state and, in some cases, b) data specifying a predicted immediate reward value that represents an immediate reward that would be received if the agent performed the input action when the environment is in the input environment state. For example, the immediate reward value can be a numerical value that represents a progress in completing the task as a result of performing the input action when the environment is in the input environment state.

The system processes (206), using the prediction model and in accordance with trained values of the prediction model parameters, the hidden state corresponding to the predicted next environment state and to generate as output a) a predicted policy output that defines a score distribution over the set of possible actions and b) a value output that represents a value of the environment being in the predicted next environment state to performing the task.

As a final step of the planning iteration, the system then evaluates the leaf node and updates the statistics data for the edges traversed during the search based on the model outputs. The system may use the score corresponding to the new edge from the score distribution defined by the prediction model output as the prior probability P for the new edge. The system may also determine the action score Q for the new edge from the value output the prediction model network.

For each edge that was traversed during the planning iteration, the system may increment the visit count N for the edge by a predetermined constant value, e.g., by one. The system may also update the action score Q for the edge using the predicted value for the leaf node by setting the action score Q equal to the new average of the predicted values of all searches that involved traversing the edge.

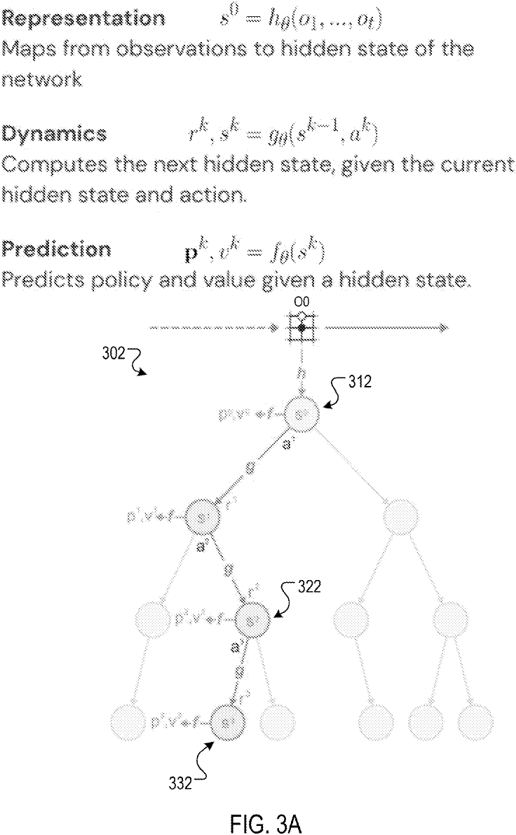

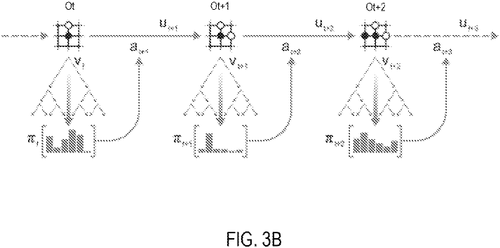

FIG. 3A is an example illustration of performing one planning iteration to generate plan data. The planning iteration in this example includes a sequence of three actions resulting in a predicted rollout of three states after a current state of the environment.

As depicted, the planning iteration begins with traversing a state tree 302 and continues until the state tree reaches a leaf state, i.e., a state that is represented by a leaf node in the state tree, e.g., node 332, followed by expanding the leaf node and evaluating the newly added edges using the dynamics model g and prediction model f, as described above with reference to steps 204-206, and updating the statistics data for the edges traversed during the search based on the predicted return for the leaf node. When traversing the state tree, the system selects the edges to be traversed (which correspond to the sequence of actions a¹ - a³ that have been selected during planning) according to the compiled statistics of corresponding node-edge pairs of state tree.

Notably, unlike conventional systems, the system does not perform the planning iteration by making use of a simulator of the environment, i.e., does not use a simulator of the environment to determine which state the environment will transition into as a result of a given action being performed in a given state. In particular, the system makes no attempt to determine a simulated or predicted observation of the state the environment will transition into as a result of a given action being performed in a given state. Instead, the system performs the planning iteration based on the hidden state outputs of the dynamics model g.

For example, as depicted in FIG. 3A, when node 322 was a leaf node of the state tree amidst the planning and if the system were to expand the leaf node 322, the system could do by (i) processing a hidden state s² and data specifying an action a³ using the dynamics model g to generate as output a hidden state s³ corresponding to a predicted next environment state and, in some cases, data specifying a predicted immediate reward value r³, and then (ii) processing the hidden state s³ generated by the dynamics model g using the prediction model ƒ to generate as output a predicted policy output p³ and a value output _{V}3. Thus, the system can perform the planning using only these hidden states, e.g., hidden states s1 - s³, whereas conventional systems are typically required to perform the planning by iteratively reconstructing a full observation that characterizes each state, e.g., an observation having the same format or modality as the received current observation 0⁰ which characterizes the current environment state of the environment.

The example of FIG. 3A shows a rollout of a total of three predicted future environment states starting from the current environment state, where each hidden state corresponding to a respective environment state is associated with a corresponding predicted policy output, a predicted value, a predicted immediate reward value, and an action selected using an actual action selection policy. However, a different, e.g., larger, number of hidden states and a different number of predicted policy outputs, predicted values, and predicted immediate reward values may be generated by the system than what is illustrated in FIG. 3A.

After performing the multiple planning iterations as described above to generate plan data, the system proceeds to select, from the set of actions, an action to be performed by the agent in response to the current observation based on the generated plan data (208). Specifically, the plan data can include statistics data that has been compiled during planning for each of some or all outgoing edges of the root node of the state tree, i.e., the node that corresponds to the state characterized by the current observation, and the system can select the action based on the statistics data for the node-edge pairs corresponding to the root node.

In some implementations, the system can make this selection based on the visit counts of the edges that correspond to the possible actions that can be performed by the agent in response to an observation corresponding to the environment state characterized by the root node of the state tree. In the example of FIG. 3A, the system can select the action proportional to the visit count for each outgoing edge of the root node 312 of the state tree 302.

In some implementations, the system can make this selection by determining, from the sequences of actions in the plan data, a sequence of actions that has a maximum associated value output and thereafter selecting, as the action to be performed by the agent in response to the current observation, the first action in the determined sequence of actions. In the example of FIG. 3A, the system can select a¹ as the action to be performed, assuming the sequence of actions a¹ - a³ has the maximum associated value output among all different sequences of actions that have been generated over multiple planning iterations.

FIG. 3B is an example illustration of selecting actions to be performed by an agent based on the generated plan data. For a given observation, e.g., observation o_{t,} of a corresponding state of the environment, an action, e.g., action aₜ₊₁, is selected by the system and based on processing an iteration of process 200, as described above. The actual performance of the selected action by the agent progresses the environment to transition into a new state, from which a new observation, e.g., observation oₜ₊₁, and a corresponding reward, e.g., reward uₜ₊₁, is generated. Correspondingly, another iteration of process 200 can be performed by the system in order to select a new action, e.g., action aₜ₊₂, to be performed by the agent in response to the new state characterized by the new observation.

The example of FIG. 3B shows a trajectory including a total of three observations oₜ - oₜ₊₂, each characterizing a respective state of the environment. But in reality, the trajectory can include more observations that collectively characterize a longer succession of transitions between environment states, and thus can capture interaction information between the agent and the environment when performing any of a variety of tasks, including long episode tasks. Each trajectory of observations, actions, and, in some cases, rewards generated in this way may optionally be stored at a replay memory of the system that can later be used to assist in the training of the system.

The above description describes implementations in which each valid action in the set of actions is evaluated when evaluating any given leaf node. However, in some other implementations, the set of actions is very large or continuous such that evaluating each action is not feasible or excessively computationally expensive.

In those implementations, the system can select actions to be performed by an agent using an action sampling technique in addition to the aforementioned planning techniques, as described in more detail below with reference to FIG. 4.

FIG. 4 is a flow diagram of another example process 400 for selecting actions to be performed by an agent interacting with an environment. For convenience, the process 400 will be described as being performed by a system of one or more computers located in one or more locations. For example, a reinforcement learning system, e.g., the reinforcement learning system 100 of FIG. 1, appropriately programmed in accordance with this specification, can perform the process 400.

The system receives a current observation (e.g., an image or a video frame) characterizing a current environment state of the environment (402) and generates a hidden state corresponding to the current state of the environment by using the representation model.

The system then repeatedly performs the following steps of 404-412 to perform multiple planning iterations to generate plan data that indicates a respective value to performing the task of the agent performing each of multiple actions from the set of actions in the environment and starting from the current environment state. As similarly described above, this involves selecting a sequence of actions to be performed by the agent starting from the current environment state by traversing a state tree of the environment, where the state tree of the environment has nodes that represent environment states of the environment and edges that represent actions that can be performed by the agent that cause the environment to transition states.

At each planning iteration, the system traverses, using statistics for node-edge pairs in the state tree, the state tree starting from a root node of the state tree representing the current environment state until reaching a leaf node in the state tree (404). Generally, a leaf node is a node in the state tree that has no child nodes, i.e., is not connected to any other nodes by an outgoing edge.

The system processes (406), using the prediction model and in accordance with trained values of the prediction model parameter, a hidden state corresponding to an environment state represented by the leaf node and to generate as output a) a predicted policy output that defines a score distribution over the set of actions and b) a value output that represents a value of the environment being in the state represented by the leaf node to performing the task.

The system samples a proper subset of the set of actions (408). The system can do this by generating a sampling distribution from the score distribution, and then sampling a fixed number of samples from the sampling distribution. This is described in more detail above in FIG. 1, but, in brief, can involve scaling the scores in the score distribution using a temperature parameter.

The system updates the state tree based on the sampled actions (410). For each sampled action, the system adds, to the state tree, a respective outgoing edge from the leaf node that represents the sampled action.

The system also updates the statistics data for the node-edge pairs corresponding to the leaf node (412). For each sampled action, the system associates the respective outgoing edge representing the sampled action with a prior probability for the sampled action that is derived from the predicted policy output.

To determine the prior probability for the sampled action, the system applies a correction factor to the score for the action in the score distribution defined by the predicted policy output of the prediction model. The correction factor can be determined based on (i) a number of times that the sampled action was sampled in the fixed number of samples and (ii) a score assigned to the sampled action in the sampling distribution. For example, the correction factor is equal to a ratio of (i) a ratio of the number of times that the sampled action was sampled in the fixed number of samples to the total number of samples in the fixed number and (ii) the score assigned to the sampled action in the sampling distribution.

After performing the multiple planning iterations as described above to generate plan data, the system proceeds to select an action to be performed by the agent in response to the current observation using the plan data (414), for example by making the selection using the visit count for each outgoing edge of the root node of the state tree.

Thus, more generally, to account for the fact that only a subset of the actions were sampled, the system generates the prior probabilities for the sampled actions using a correction factor and then proceeds to use the (corrected) prior probabilities to select actions and, when sampling is performed during training, as described in the remainder of this specification.

FIG. 5 is a flow diagram of an example process 500 for training a reinforcement learning system to determine trained values of the model parameters. For convenience, the process 500 will be described as being performed by a system of one or more computers located in one or more locations. For example, a reinforcement learning system, e.g., the reinforcement learning system 100 of FIG. 1, appropriately programmed in accordance with this specification, can perform the process 500.

The system obtains a trajectory from the replay memory (502). For example, the trajectory can be one of a batch of trajectories sampled from the replay memory. The trajectory can include a sequence of observations each associated with an actual action performed by the agent (or another agent) in response to the observation of the environment (or another instance of the environment) and, in some cases, a reward received by the agent.

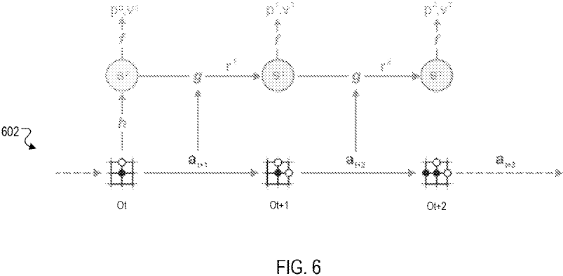

FIG. 6 is an example illustration of training a reinforcement learning system to determine trained values of the model parameters. As depicted, the trajectory 602 includes a total of three observations oₜ - oₜ₊₂ each characterizing a corresponding state of the environment. The trajectory 602 also includes, for each observation, e.g., observation oₜ: an actual action, e.g., action aₜ₊₁, performed by the agent in response to the observation, and an actual reward, e.g., reward uₜ₊₁, received by the agent in response to performing the actual action when the environment is in a state characterized by the observation.

The system processes an observation (the “current observation”) and, in some cases, one or more previous observations the precede the current observation in the trajectory using the representation model and in accordance with the current values of the representation model parameters to generate a hidden state corresponding to a current state of the environment (504).

As depicted in the example of FIG. 6, the system processes an observation oₜ using the representation model to generate a hidden state s⁰ corresponding to the current state.

The system uses the dynamics and prediction models to perform a rollout of a predetermined number of states of the environment that are after the current state (506), i.e., to generate a predetermined number of hidden states that follow the hidden state corresponding to the current state of the environment.

To perform the rollout, as depicted in the example of FIG. 6, the system repeatedly (i.e., at each of multiple training time steps) processes a) a hidden state, e.g., hidden state ₛ0, and b) data specifying a corresponding action in the trajectory, e.g., action aₜ₊₁, (i.e., the actual action performed by the agent in response to the current state) using the dynamics model and in accordance with current values of the dynamics model parameters to generate as output a) a hidden state that corresponds to a predicted next environment state, e.g., hidden state s¹, and, in some cases, b) data specifying a predicted immediate reward value, e.g., predicted immediate reward r¹. The system also repeatedly processes the hidden state corresponding to the predicted next environment state, e.g., hidden state s¹, using the prediction model and in accordance with current values of the prediction model parameters and to generate as output a) a predicted policy output, e.g., predicted policy output p¹ and b) a value output, e.g., value output ν¹.

The system evaluates an objective function (508) which measures quantities most relevant to planning.

In particular, the objective function can measure, for each of the plurality of observations in the trajectory, e.g., observation oₜ, and for each of one or more subsequent hidden states that follow the state represented by the observation in the trajectory, e.g., hidden state s¹: (i) a policy error between the predicted policy output for the subsequent hidden state generated conditioned on the observation, e.g., predicted policy output p¹, and an actual policy that was used to select an actual action, e.g., action aₜ₊₁, in response to the observation, (ii) a value error between the value predicted for the subsequent hidden state generated conditioned on the observation, e.g., the value output ν¹, and a target value for the subsequent hidden state, and (iii) a reward error between the predicted immediate reward for the subsequent hidden state generated conditioned on the observation, e.g., predicted immediate reward r¹, and an actual immediate reward corresponding to the subsequent hidden state. For example, the target value for the subsequent hidden state can be a bootstrapped n-step return received by the agent starting from the subsequent hidden state.

For example, the objective function may be evaluated as

$${l}_{1} \left(θ\right) = {\sum }_{h = 0}^{K} {l}^{r} \left({u}_{l + k} , {r}_{t}^{k}\right) + r \left({z}_{l + k} , {v}_{t}^{k}\right) + {l}^{p} \left({n}_{k + k} , {p}_{t}^{k}\right) + e {\left‖θ\right‖}^{2}$$

where I^{r}(u,r) = ϕ(u)^{T} log^{r} is a first error term that evaluates a difference between the predicted immediate reward values and the target (actual) reward u, I^{r}(z,q)═ϕ(z)^{T} log q is a second error term that evaluates the difference between the predicted value outputs and the target value

$${z}_{t} = {u}_{t + 1} + γ {u}_{t + 2} + … + {γ}^{n - 1} {u}_{t + n} + {γ}^{n} {v}_{l + n} ,$$

and

$$V ( π , p ) = {π}^{T} log p$$

is a third error term that evaluates the difference between the predicted policy outputs and the actual action selection policy π, e.g., a Monte-Carlo tree search policy. For example, the difference can be evaluated as a difference between (i) the empirical sampling distribution over the set of possible actions derived from the visit counts of the outgoing edges of the root node of the state tree and (ii) the score distribution over the set of possible actions defined by the predicted policy output of the prediction model.

In this example, c||θ||² is the L2 regularization term, y is the discounting factor used when computing the target values z as bootstrapped n-step targets, and ϕ(x) refers to the representation of a real number x through a linear combination of its adjacent integers, which effectively transforms a scalar numerical value x into equivalent categorical representations.

The system updates the parameters values of the representation, dynamics, and prediction models (510) based on computing a gradient of the objective function with respect to model parameters and by using an appropriate training technique, e.g., an end-to-end by backpropagation-through-time technique.

In general the system can repeatedly perform the process of 500 to repeatedly update the model parameter values to determine the trained values of the model parameters until a training termination criteria has been satisfied, e.g., after a predetermined number of training iteration has been completed or after a predetermined amount of time for the training of the system has elapsed.

Instead of or in addition to determining trained values the representation, dynamics, and prediction model parameters by performing the aforementioned process 400, the system can do so by using a reanalyze technique.

In some cases, the system interleaves the training with reanalyzing of the reinforcement learning system. During reanalyzing, the system revisits the trajectories previously sampled from the replay memory and uses the trajectories to fine-tine the parameter values of the representation, dynamics, and prediction models determined as a result of training the system on these trajectories. For example, every time the process 400 has been repeatedly performed for a predetermined number of iterations, the system can proceed to perform one or more reanalyzing processes as described below to adjust the current values of model parameters determined as of the training iterations that have been performed so far.

In other cases, the system can update model parameter values based entirely on reanalyze. For example, the system may employ reanalyze techniques in cases where collecting new trajectory data by controlling the agent to interact with the environment during the training is expensive or otherwise infeasible, or in cases where only earlier experiences of the agent interacting with the environment while controlled by a different policy is available. In these cases, the system samples the stored trajectories from the replay memory and uses the sampled trajectories to adjust, i.e., from initial values rather than already adjusted values, the parameter values of the representation, dynamics, and prediction models.

FIG. 7 is a flow diagram of an example process 700 for reanalyzing a reinforcement learning system to determine trained values of the model parameters. For convenience, the process 700 will be described as being performed by a system of one or more computers located in one or more locations. For example, a reinforcement learning system, e.g., the reinforcement learning system 100 of FIG. 1, appropriately programmed in accordance with this specification, can perform the process 700.

The system obtains an observation (the “current observation”) (702) which can be one of the observations included in a trajectory previously sampled from the replay memory during training. For example, the observation can be an observation in the trajectory obtained by the system at step 502 of the process 500.

The system performs a plurality of planning iterations (704) guided by the outputs generated by the dynamics model and the prediction model, including selecting multiple sequences of actions to be performed by the agent starting from the current environment state, as described above with reference to FIG. 2. In particular, to generate the hidden state corresponding to the observation and to expand leaf nodes during reanalyzing, the system runs the representation, dynamics, and prediction models in accordance with the latest parameter values of these models, i.e., the parameter values that have been recently updated as a result of the performing the process 500 or as a result of the reanalyze of the system.

The system evaluates a reanalyze objective function (706) including re-computing new target policy outputs and new target value outputs, and then substituting the re-computed new target policy outputs and new target value outputs into an objective function used during training, e.g., the example objective function of Equation 2.

Specifically, for each of the plurality of observations in the trajectory, and for each of one or more subsequent hidden states that follow the state represented by the observation in the trajectory: the new target policy output can determined using the actual action selection policy π, e.g., a Monte-Carlo tree search policy, guided by the outputs generated by the representation, dynamics, and prediction models in accordance with the recently updated parameter values. And the target value output can be a bootstrapped n-step target value which is computed as

$${z}_{t} = {u}_{t + 1} + ϒ {u}_{t + 2} + ... + {ϒ}^{n - 1} {u}_{t + n} + {ϒ}^{n} {v}_{t + n}^{-}$$

, where

$${v}^{-} = {f}_{θ -} \left({g}^{0}\right)$$

denotes a value output generated by using the prediction model f from processing a hidden state s⁰ in accordance with the recently updated parameter values θ⁻ of the prediction model.

To increase sample reuse and avoid overfitting of the value function, when evaluating the reanalyze objective function, the system may additionally adjust some hyperparameter values associated with the training objective function, for example lowering the weighing factor for the target value outputs and reducing the number of steps used in computing the bootstrapped n-step target value.

The system updates, e.g., fine-tunes, the parameters values of the representation, dynamics, and prediction models (708) based on computing a gradient of the reanalyze objective function with respect to model parameters and by using an appropriate training technique, e.g., an end-to-end by backpropagation-through-time technique.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1-10. (canceled)

11. A method for selecting, from a set of actions, actions to be performed by an agent interacting with an environment to cause the agent to perform a task, the method comprising:
receiving a current observation characterizing a current environment state of the environment;
performing a plurality of planning iterations to generate plan data that indicates a respective value to performing the task of the agent performing each of the set of actions in the environment and starting from the current environment state, wherein performing each planning iteration comprises:
selecting a sequence of actions to be performed by the agent starting from the current environment state based on outputs generated by:
(i) a dynamics model that is configured to receive as input a) a hidden state corresponding to an input environment state and b) an input action from the set of actions and to generate as output at least a hidden state corresponding to a predicted next environment state that the environment would transition into if the agent performed the input action when the environment is in the input environment state; and
(ii) a prediction model that is configured to receive as input the hidden state corresponding to the predicted next environment state and to generate as output a) a predicted policy output that defines a score distribution over the set of actions and b) a value output that represents a value of the environment being in the predicted next environment state to performing the task; and
selecting, from the set of actions, an action to be performed by the agent in response to the current observation based on the generated plan data.

12. The method of claim 11, wherein the dynamics model also generates as output a predicted immediate reward value that represents an immediate reward that would be received if the agent performed the input action when the environment is in the input environment state, wherein the immediate reward value is a numerical value that represents a progress in completing the task as a result of performing the input action when the environment is in the input environment state.

13. The method of claim 11, wherein selecting the sequence of actions further comprises selecting the sequence of action based on:
outputs generated by a representation model that is configured to receive a representation input comprising the current observation and to generate as output a hidden state corresponding to the current state of the environment.

14. The method of claim 13, wherein the representation input further comprises one or more previous observations characterizing one or more previous states that the environment transitioned into prior to the current state.

15. The method of claim 13, wherein the representation model, the dynamics model, and the prediction model are jointly trained end-to-end on sampled trajectories from a set of trajectory data.

16. The method of claim 15, wherein the representation model, the dynamics model, and the prediction model are jointly trained end-to-end on an objective that measures, for each of a plurality of particular observations:
for each of one or more subsequent states that follow the state represented by the particular observation in the trajectory:
(i) a policy error between the predicted policy output for the subsequent state generated conditioned on the particular observation and an actual policy that was used to select an action in response to the observation, and
(ii) a value error between the value predicted for the subsequent state generated conditioned on the particular observation and an actual return received starting from the subsequent state.

17. The method of claim 16, wherein the objective also measures, for each of the plurality of particular observations:
for each of the one or more subsequent states that follow the state represented by the particular observation in the trajectory:
a reward error between the predicted immediate reward for the subsequent state generated conditioned on the particular observation and an actual immediate reward corresponding to the subsequent state.

18. The method of claim 15, wherein the dynamics model and the representation model are not trained to model semantics of the environment through the hidden states.

19. The method of wherein the actual return starting from the subsequent state is a bootstrapped n-step return.

20. The method of claim 11, wherein selecting, from the set of actions, an action to be performed by the agent in response to the current observation based on the generated plan data comprises selecting the action using a markov decision process (MDP) planning algorithm.

21. The method of claim 20, wherein selecting the sequence of actions for each planning iteration and selecting the action to be performed by the agent are performed using a monte carlo tree search (MCTS) algorithm.

22. The method of claim 20, wherein selecting, from the set of actions, an action to be performed by the agent in response to the current observation based on the generated plan data comprises:
determining, from the sequences of actions in the plan data, a sequence of actions that has a maximum associated value output; and
selecting, as the action to be performed by the agent in response to the current observation, the first action in the determined sequence of actions.

23. A system comprising one or more computers and one or more storage devices storing instructions that when executed by the one or more computers cause the one or more computers to perform operations for selecting, from a set of actions, actions to be performed by an agent interacting with an environment to cause the agent to perform a task, wherein the operations comprise:
receiving a current observation characterizing a current environment state of the environment;
performing a plurality of planning iterations to generate plan data that indicates a respective value to performing the task of the agent performing each of the set of actions in the environment and starting from the current environment state, wherein performing each planning iteration comprises:
selecting a sequence of actions to be performed by the agent starting from the current environment state based on outputs generated by:
(i) a dynamics model that is configured to receive as input a) a hidden state corresponding to an input environment state and b) an input action from the set of actions and to generate as output at least a hidden state corresponding to a predicted next environment state that the environment would transition into if the agent performed the input action when the environment is in the input environment state; and
(ii) a prediction model that is configured to receive as input the hidden state corresponding to the predicted next environment state and to generate as output a) a predicted policy output that defines a score distribution over the set of actions and b) a value output that represents a value of the environment being in the predicted next environment state to performing the task; and
selecting, from the set of actions, an action to be performed by the agent in response to the current observation based on the generated plan data.

24. One or more computer storage media storing instructions that when executed by one or more computers cause the one or more computers to perform the operations for selecting, from a set of actions, actions to be performed by an agent interacting with an environment to cause the agent to perform a task, wherein the operations comprise:
receiving a current observation characterizing a current environment state of the environment;
performing a plurality of planning iterations to generate plan data that indicates a respective value to performing the task of the agent performing each of the set of actions in the environment and starting from the current environment state, wherein performing each planning iteration comprises:
selecting a sequence of actions to be performed by the agent starting from the current environment state based on outputs generated by:
(i) a dynamics model that is configured to receive as input a) a hidden state corresponding to an input environment state and b) an input action from the set of actions and to generate as output at least a hidden state corresponding to a predicted next environment state that the environment would transition into if the agent performed the input action when the environment is in the input environment state; and
(ii) a prediction model that is configured to receive as input the hidden state corresponding to the predicted next environment state and to generate as output a) a predicted policy output that defines a score distribution over the set of actions and b) a value output that represents a value of the environment being in the predicted next environment state to performing the task; and
selecting, from the set of actions, an action to be performed by the agent in response to the current observation based on the generated plan data.

25. The system of claim 23, wherein the dynamics model also generates as output a predicted immediate reward value that represents an immediate reward that would be received if the agent performed the input action when the environment is in the input environment state, wherein the immediate reward value is a numerical value that represents a progress in completing the task as a result of performing the input action when the environment is in the input environment state.

26. The system of claim 23, wherein selecting the sequence of actions further comprises selecting the sequence of action based on:
outputs generated by a representation model that is configured to receive a representation input comprising the current observation and to generate as output a hidden state corresponding to the current state of the environment.

27. The system of claim 26, wherein the representation input further comprises one or more previous observations characterizing one or more previous states that the environment transitioned into prior to the current state.

28. The system of claim 26, wherein the representation model, the dynamics model, and the prediction model are jointly trained end-to-end on sampled trajectories from a set of trajectory data.

29. The system of claim 28, wherein the representation model, the dynamics model, and the prediction model are jointly trained end-to-end on an objective that measures, for each of a plurality of particular observations:
for each of one or more subsequent states that follow the state represented by the particular observation in the trajectory:
(i) a policy error between the predicted policy output for the subsequent state generated conditioned on the particular observation and an actual policy that was used to select an action in response to the observation, and
(ii) a value error between the value predicted for the subsequent state generated conditioned on the particular observation and an actual return received starting from the subsequent state.

30. The system of claim 23, wherein selecting the sequence of actions for each planning iteration and selecting the action to be performed by the agent are performed using a monte carlo tree search (MCTS) algorithm.
